(19) United States
(12) Patent Application Publication
(10) Pub. No.: US 2009/0271661 A1
(43) Pub. Date: Oct. 29, 2009

(54) STATUS TRANSITION TEST SUPPORT DEVICE, STATUS TRANSITION TEST SUPPORT METHOD, AND RECORDING MEDIUM

(75) Inventors: Kiyotaka MIYAI, Kyoto (JP); Kiyotaka KASUBUCHI, Kyoto (JP); Hiroshi YAMAMOTO, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG.CO., LTD.

(21) Appl. No.: 12/403,658

(22) Filed: Mar. 13, 2009

(30) Foreign Application Priority Data
Apr. 23, 2008 (JP) P2008-112490

(51) Int. Cl. G06F 11/263

(52) U.S. Cl. 714/35; 714/E11.177

(57) ABSTRACT

A status transition table generation portion generates a status transition table containing combination information cells provided in the form of a matrix for describing information corresponding to combinations of internal status and event. In a status transition table design support portion, a test path generation portion generates a test path including a series of test cases to be executed as a status transition test, based on information accepted by an operation specification information input acceptance portion. In a test support portion, a test cell highlight portion highlights a combination information cell associated with the next test case to be executed, during execution of the status transition test, and a test result history, an error replication procedure, and test progress are displayed on a display portion.

### BACKGROUND OF THE INVENTION

1. Field of the Invention

The present invention relates to devices for supporting efficient software system design, development, maintenance, etc. More particularly, the invention relates to a status transition test support device for supporting efficient execution of a test (hereinafter, referred to as a “status transition test”) using a status transition table describing internal status transition of a system.

2. Description of the Background Art

Conventionally, for software system design or development, it is often the case that a status transition table describing internal status transition (change) of a system is created. The status transition table consists of a plurality of sections partitioned by vertical and horizontal lines (note that each section is referred to as a “cell”.). In the status transition table, each column (or each row) is associated with an internal status that may be taken by the system, while each row (or each column) is associated with an event that may occur in the system. Also, cells where a column and a row intersect with each other have a description (input) as to “what process (referred to as, for example, “behavior” or “action”) is executed and what internal status is brought about by transition” when an event associated with the row occurs during an internal status associated with the column. The status transition table represents without omission all system operations associated with “combinations of system internal status and event”, for example, such that any abnormal operation due to erroneous omission during the course of development is prevented from occurring. In particular, when designing or developing an embeddable software system (a software system which is embedded in electronic equipment, such as an industrial instrument, a consumer electronic appliance, or a cell phone, and runs on a microcomputer), it is essential to use the status transition table in order to describe system operations and perform a status transition test.

For example, conventional techniques related to the status transition table include the following. Japanese Laid-Open Patent Publication No. 1-261726 discloses a scheme for efficiently editing the status transition table by representing the transitional relationship between statuses in the form of a tree. Japanese Laid-Open Patent Publication No. 6-75817 discloses a method (an operation history display method for status transition rules) for improving the efficiency of debugging by indicating status transition with arrows. Japanese Laid-Open Patent Publication No. 11-110351 discloses a method for controlling transition from one status to another based on the status transition table. Japanese Laid-Open Patent Publication No. 2002-230062 discloses a device for supporting system design by including a system generation means for converting contents of processing (a program) inputted in the form of a status transition table into an executable system. Japanese Laid-Open Patent Publication No. 2006-112852 discloses a method for creating a test scenario by combining scenarios generated by a plurality of scenario generation algorithms.

Conventionally, there are the following problems with execution of the status transition test. When the designer of a system differs from the performer of the status transition test, it is difficult for the test performer to identify a “combination of system internal status and event” with which to start the test. Even after the test is started, it is still difficult for the test performer to find such a combination. Also, in the case of a system in which a variety of types of status transition can occur, it is not easy to figure out by which route (test path to be described later) the test has been executed, and therefore it is difficult to efficiently execute the status transition test. Furthermore, when an error occurs during the test, it is difficult to figure out the procedure for replicating the error. As described above, “how to efficiently execute the status transition test” remains an issue to be addressed.

Japanese Laid-Open Patent Publication Nos. 1-261726, 6-75817, 11-110351, and 2002-230062 describe, for example, control of the status transition or editing of the status transition table, but the status transition test is not mentioned. Also, Japanese Laid-Open Patent Publication No. 2006-112852 mentions creation of the test scenario, which, however, does not mean that the status transition test is efficiently executed.

### SUMMARY OF THE INVENTION

Therefore, an object of the present invention is to provide a status transition test support device for supporting efficient execution of the status transition test.

The present invention has the following features to attain the object mentioned above.

One aspect of the present invention is directed to a status transition test support device for supporting execution of a status transition test for transition between internal statuses to be taken by a system, the test including a plurality of test cases, the device including:

a status transition table generation portion for generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, the combination information cells being associable with the test cases included in the status transition test, the described information being either operation specification information or unavailability information, the operation specification information specifying contents of processing and an internal status after transition, the unavailability information indicating that a combination of internal status and event does not occur in the system;

an operation specification information input acceptance portion for accepting input of the operation specification information into the combination information cells;

a test path generation portion for generating a test path including a series of test cases to be executed as the status transition test, based on the operation specification information accepted by the operation specification information input acceptance portion;

a test result holding portion for holding test results for the test cases included in the test path generated by the test path generation portion, and execution order specification information for specifying the order of test execution; and

a test result recording portion for recording a test result externally inputted for each test case to the test result holding portion, along with the execution order specification information.

According to this configuration, a test path to be executed as the status transition test is generated by the test path generation portion based on “combinations of internal status and event” inputted into cells (combination information cells) of the status transition table by the operator. Thus, it is possible to significantly shorten the time conventionally required for test path generation. In addition, when the status transition test is executed, a test result for each test case included in the test path and information for specifying the order of test execution (execution order specification information) are recorded to the test result holding portion based on input by the operator. Thus, it is possible to determine in which test path and up to which test case has already been executed based on data held by the test result holding portion.

Preferably, the device thus configured further includes a test cell highlight portion for highlighting a combination information cell associated with the next test case to be executed, based on the test path generated by the test path generation portion.

According to this configuration, a combination information cell associated with the next test case to be executed (hereinafter, referred to as a “test cell”) is highlighted during execution of the status transition test. Thus, it is possible to eliminate the necessity for the operator to find the test cell by him/herself, resulting in quick execution of the status transition test.

Preferably, the device thus configured further includes a test path candidate display portion for displaying a plurality of test paths including any unexecuted test case as candidates for the next test path to be executed, based on the test result held by the test result holding portion for each test case.

According to this configuration, any test path including an unexecuted test case is displayed as a candidate for the next test path to be executed during execution of the status transition test. Thus, it is possible to eliminate the necessity for the operator to find by him/herself the test path to be executed, resulting in quick execution of the status transition test.

Preferably, the device thus configured further includes a test result history display portion for displaying test results for any executed test cases, along with an information for identifying test cases, in order of test execution, based on the test result for each test case and the execution order specification information which are held by the test result holding portion.

According to this configuration, test results for any executed ones of a series of status transition tests are displayed in order of test execution. Thus, it is possible to readily find out the execution status of the status transition test (the order of test execution, tests results for test cases, and so on).

In the device thus configured, preferably, the test result holding portion holds information indicating whether the test was passed or failed as the test result, and the device further includes:

a failed test replication procedure display portion for displaying execution methods for one or more test cases in order of test execution for the one or more test cases, based on the test result for each test case and the execution order specification information which are held by the test result holding portion, provided that the one or more test cases have been executed before executing a test case whose test result is fail.

According to this configuration, when there is any test case with test result “error (fail)”, the test execution procedure for replicating the error is displayed. Therefore, the operator can perform error replication more readily. Thus, it is possible to readily trace the cause of the error, thereby achieving efficient system development.

Preferably, the device thus configured further includes a progress display portion for displaying progress of the status transition test based on the test result held by the test result holding portion for each test case.

According to this configuration, the progress of the status transition test is displayed. Thus, it is possible to readily manage the progress of system development including the status transition test.

In the device thus configured, preferably, the execution order specification information contains for each test case the year, month, day, and time of test execution.

According to this configuration, the year, month, day, and time of test execution is recorded to the test result holding portion as the execution order specification information. Since information regarding the year, month, day, and time can be readily acquired, it is possible to relatively readily hold information for specifying the order of test execution in the test result holding portion.

Another aspect of the present invention is directed to a computer-readable recording medium having recorded thereon a status transition test support program for use with a status transition test support device for supporting execution of a status transition test for transition between internal statuses to be taken by a system, the test including a plurality of test cases, the program causing the device to execute the following steps:

a status transition table generation step of generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, the combination information cells being associable with the test cases included in the status transition test, the described information being either operation specification information or unavailability information, the operation specification information specifying contents of processing and an internal status after transition, the unavailability information indicating that a combination of internal status and event does not occur in the system;

an operation specification information input acceptance step of accepting input of the operation specification information into the combination information cells;

a test path generation step of generating a test path including a series of test cases to be executed as the status transition test, based on the operation specification information accepted in the operation specification information input acceptance step; and

a test result recording step of recording a test result externally inputted for each test case included in the test path generated in the test path generation step to a predetermined test result holding portion, along with execution order specification information for specifying the order of test execution.

Still another aspect of the present invention is directed to a status transition test support method for supporting execution of a status transition test for transition between internal statuses to be taken by a system, the test including a plurality of test cases, the method comprising:

a status transition table generation step of generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, the combination information cells being associable with the test cases included in the status transition test, the described information being either operation specification information or unavailability information, the operation specification information specifying contents of processing and an internal status after transition, the unavailability information indicating that a combination of internal status and event does not occur in the system;

an operation specification information input acceptance step of accepting input of the operation specification information into the combination information cells;

a test path generation step of generating a test path including a series of test cases to be executed as the status transition test, based on the operation specification information accepted in the operation specification information input acceptance step; and

a test result recording step of recording a test result externally inputted for each test case included in the test path generated in the test path generation step to a predetermined test result holding portion, along with execution order specification information for specifying the order of test execution.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a hardware configuration diagram for an entire system in an embodiment of the present invention;

FIG. 2 is a block diagram illustrating a configuration of a status transition test support device in the embodiment;

FIG. 3 is a diagram illustrating a configuration of a status transition table in the embodiment;

FIGS. 4A and 4B are diagrams for explaining data inputted into a combination information cell in the embodiment;

FIG. 5 is a diagram illustrating an exemplary status transition table in the embodiment where internal statuses and events are not provided in the form of hierarchical structures;

FIG. 6 is a diagram illustrating an exemplary status transition table in the embodiment where internal statuses and events are provided in the form of hierarchical structures;

FIG. 7 is a diagram illustrating a portion of a status transition table for a recovery-related system in the embodiment;

FIG. 8 is a functional block diagram showing the status transition test support device in the embodiment from the functional perspective;

FIG. 9 is a diagram illustrating the record format of a test result holding table in the embodiment;

FIG. 10 is a diagram for explaining record identification for the test result holding table in the embodiment;

FIG. 11 is a flowchart illustrating the procedure for a status transition table generation process in the embodiment;

FIG. 12 is a flowchart illustrating the procedure for a status transition table design support process in the embodiment;

FIGS. 13A to 13D are diagrams for explaining a test path in the embodiment;

FIGS. 14A to 14C are diagrams for explaining test path generation in the embodiment;

FIG. 15 is a diagram for explaining test path data in the embodiment;

FIG. 16 is a diagram for explaining generation of a new test path in the embodiment;

FIGS. 17A and 17B are diagrams for explaining recording of a “transition destination” to test path data in the embodiment;

FIG. 18 is a diagram for explaining test case addition in the embodiment;

FIGS. 19A and 19B are diagrams for explaining recording of an internal status to test path data in the embodiment;

FIGS. 20A and 20B are diagrams for explaining recording of an event to test path data in the embodiment;

FIG. 21 is a diagram illustrating exemplary data generated in the test result holding table in the embodiment where a test path including four test cases is closed;

FIG. 22 is a diagram for explaining a case where similar patterns of status transition are repeated a plurality of times in the embodiment;

FIG. 23 is a diagram illustrating an example of input to the remarks field of a combination information cell in the embodiment;

FIG. 24 is a diagram illustrating exemplary data generated in the test result holding table in the embodiment where there is an input in the remarks field of a combination information cell;

FIG. 25 is a flowchart illustrating the procedure for a test support process in the embodiment;

FIG. 26 is a diagram illustrating a status transition table used for explaining the test support process in the embodiment;

FIG. 27 is a diagram illustrating three test paths used for explaining the test support process in the embodiment;

FIG. 28 is a diagram illustrating a test result holding table used for explaining the test support process in the embodiment;

FIG. 29 is a diagram illustrating a test result holding table used for explaining “test case extraction” during the test support process in the embodiment;

FIG. 30 is a diagram illustrating an exemplary dialog presenting test conditions in the embodiment;

FIGS. 31A and 31B are diagrams illustrating examples of information held in a combination information cell in the embodiment;

FIG. 32 is a diagram illustrating a test result holding table used for explaining, “test result saving” during the test support process in the embodiment;

FIG. 33 is a diagram illustrating an exemplary screen displayed during a test result history display process in the embodiment;

FIG. 34 is a diagram illustrating another exemplary screen displayed during the test result history display process in the embodiment;

FIG. 35 is a diagram illustrating an exemplary screen displayed during an error replication procedure display process in the embodiment;

FIG. 36 is a diagram illustrating an exemplary screen displayed during a transition test progress display process in the embodiment; and

FIG. 37 is a diagram illustrating another exemplary screen displayed during the transition test progress display process in the embodiment.

### DESCRIPTION OF THE PREFERRED EMBODIMENTS

Hereinafter, an embodiment of the present invention will be described with reference to the accompanying drawings.

<1. Overall Configuration>

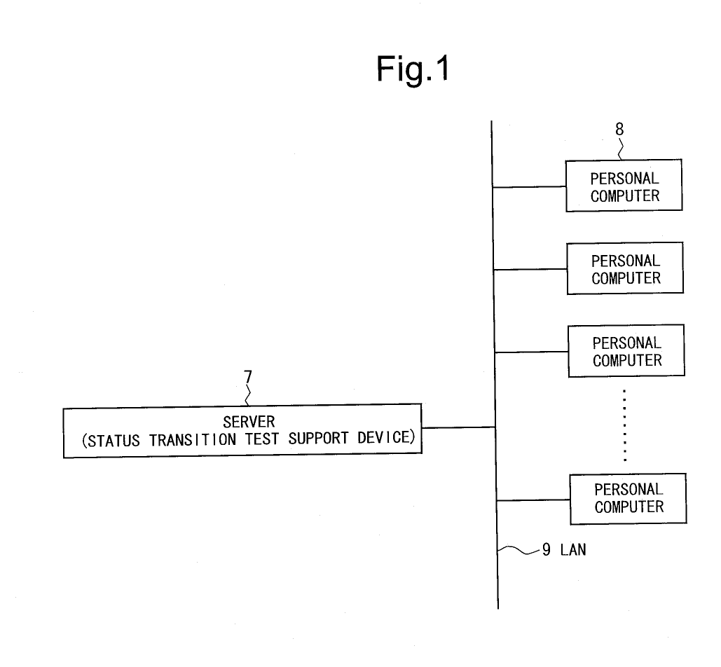

FIG. 1 is a hardware configuration diagram for an entire system in an embodiment of the present invention. This system includes a server 7 and a plurality of personal computers 8. The server 7 and each personal computer 8 are interconnected via a LAN 9. In the personal computer 8, for example, programming tasks for software system development, as well as test execution, are performed. The server 7 executes processing in accordance with requests from the personal computers 8, and stores files, databases, etc., which, for example, can be commonly referenced by the personal computers 8. In addition, the server 7 provides various functions for supporting execution of the status transition test. Note that programs to be described later (a status transition table generation program, a status transition table design support program, and a test support program) for realizing the functions for supporting execution of the status transition test may be installed in either the server 7 or the personal computer 8, but they will be described in the present embodiment as being installed in the server 7. Accordingly, the server 7 will be referred to hereinafter as the “status transition test support device”.

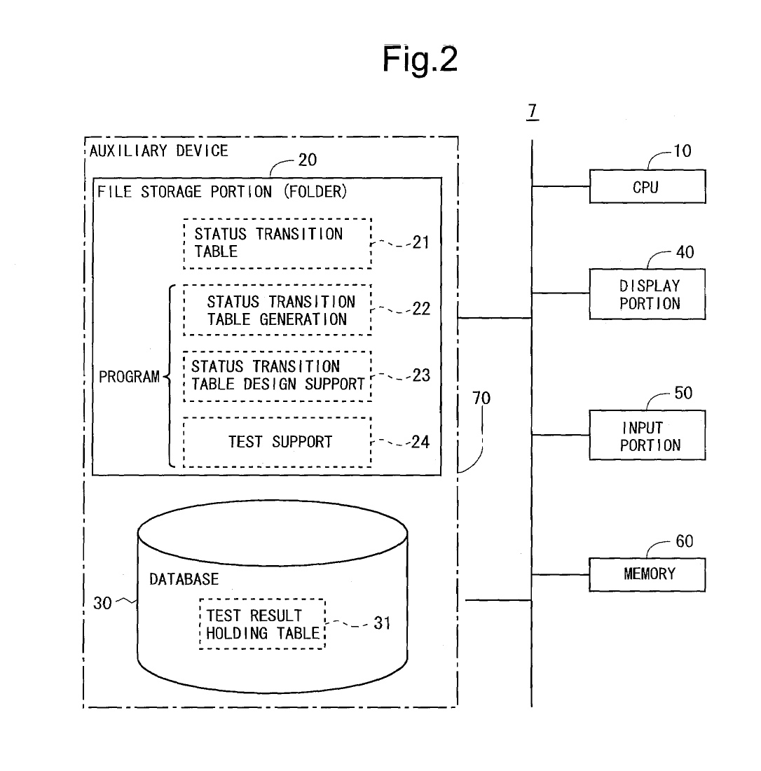

FIG. 2 is a block diagram illustrating a configuration of the status transition test support device 7. The status transition test support device 7 includes a CPU 10, a display portion 40, an input portion 50, a memory 60, and an auxiliary storage device 70. The auxiliary storage device 70 includes a file storage portion (e.g., “folder”) 20 and a database 30. The CPU 10 performs arithmetic processing in accordance with a given command. The file storage portion 20 has stored therein a status transition table 21 and three programs (execution modules) 22 to 24, which are respectively named “status transition table generation”, “status transition table design support”, and “test support”. The database 30 has stored therein a test result holding table 31 for holding status transition test results. The display portion 40 displays, for example, an operation screen for the operator to input data into the status transition table 21. The input portion 50 accepts input by the operator via a mouse and a keyboard. The memory 60 temporarily stores data required for arithmetic processing by the CPU 10. Note that the file storage portion 20 may contain as well any program other than the above-described three programs, and the database 30 may contain as well any table other than the test result holding table 31.

Note that in the following descriptions, a system to be tested concerning internal status transition using the status transition table 21 will be referred to as a “target system” (to distinguish from the system that realizes the status transition test support device 7 according to the present embodiment).

<2. Status Transition Table>

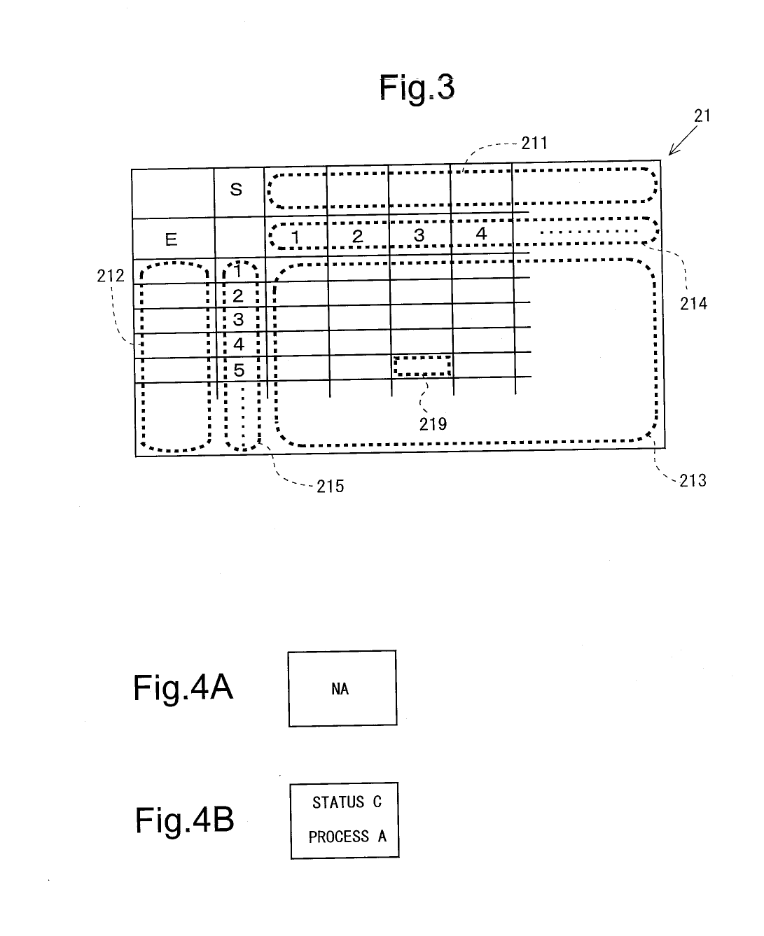

FIG. 3 is a diagram illustrating a configuration of the status transition table 21 in the present embodiment. The status transition table 21 includes an internal status input display portion 211, an event input display portion 212, a combination information input display portion 213, a column number display portion 214, and a row number display portion 215. The internal status input display portion 211 accepts data inputted by the operator, and displays the inputted data as a description of a system internal status. The event input display portion 212 accepts data inputted by the operator, and displays the inputted data as a description of an event. The combination information input display portion 213 accepts data inputted by the operator, and displays the inputted data as a description of an “internal status after transition” (hereinafter, referred to as a “transition destination”) and “contents of processing” or a description of being a “combination of internal status and event” that does not occur in the target system. The column number display portion 214 displays numbers each uniquely identifying a column. The row number display portion 215 displays numbers each uniquely identifying a row. Note that hereinafter, each cell included in the internal status input display portion 211 will be referred to as an “internal status cell”, each cell included in the event input display portion 212 as an “event cell”, and each cell included in the combination information input display portion 213 as a “combination information cell”.

The combination information cell is uniquely identified by a combination of column and row numbers (hereinafter, referred to as a “column-row number”). For example, the combination information cell denoted by reference numeral 219 in FIG. 3 is positioned where the column with “column number=3” and the row with “row number=5” intersect, and therefore identified by a column-row number of (3,5). Inputted into the combination information cell is data as shown in, for example, FIG. 4A or 4B. Where a combination information cell is not associated with any “combination of internal status and event” that can occur in the target system, a description “NA” as shown in FIG. 4A is inputted into the combination information cell. On the other hand, where a combination information cell is associated with a “combination of internal status and event” that can occur in the target system, some description as shown in, for example, FIG. 4B is inputted into the combination information cell. The upper-line part of the description shown in FIG. 4B represents a transition destination where the combination information cell is associated with a “combination of internal status and event” that can occur. The lower-line part of the description shown in FIG. 4B represents contents of processing to be executed in the target system where the combination information cell is associated with a “combination of internal status and event” that can occur. In addition, the combination information cell is configured to allow a test result to be inputted, so that when the status transition test is executed, the operator can input a test result for the combination information cell. Moreover, the combination information cell is provided with a data input area “REMARKS” such that the operator can input a memo. Note that inputting the aforementioned description “NA” into the combination information cell will be described hereinafter as “making an ‘unavailability setting’ (for the cell)”.

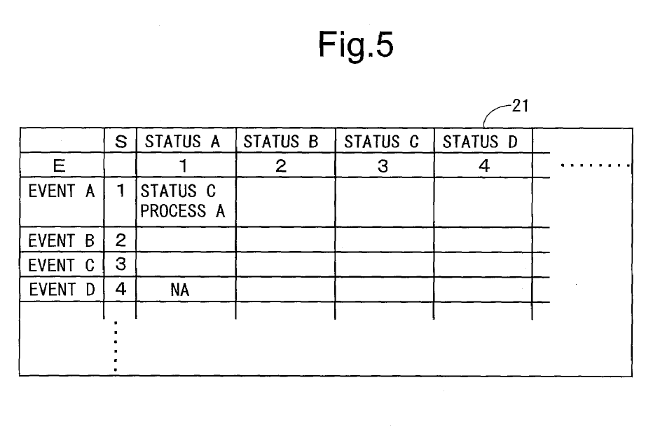

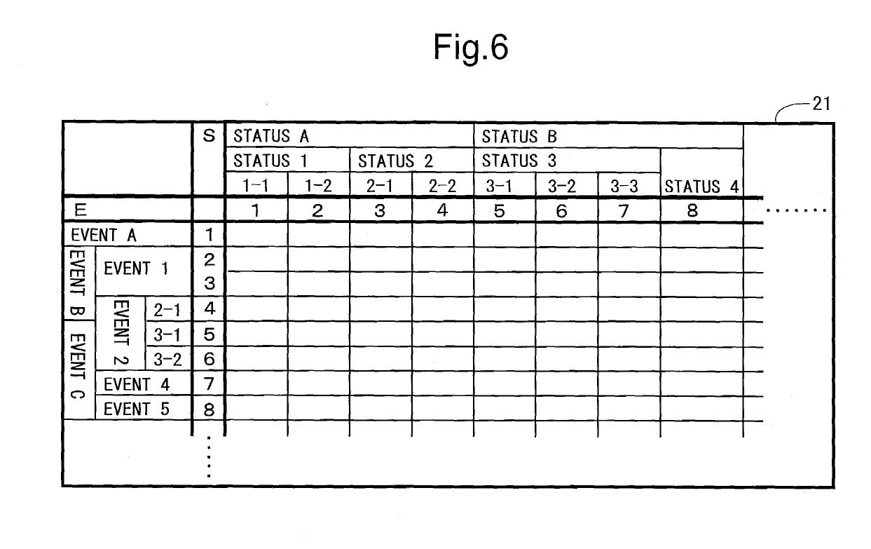

Incidentally, in the case of the status transition table 21, internal statuses and events can be represented by their respective hierarchical structures. For example, it is possible to represent that “two internal statuses ‘STATUS A1’ and ‘STATUS A2’ are included in the internal status ‘STATUS A’”. FIG. 5 is a diagram illustrating an exemplary status transition table 21 where internal statuses and events are not provided in the form of hierarchical structures. Also, FIG. 6 is a diagram illustrating an exemplary status transition table 21 where internal statuses and events are provided in the form of hierarchical structures. Note that it is also possible to provide independently either internal statuses or events in the form of a hierarchical structure.

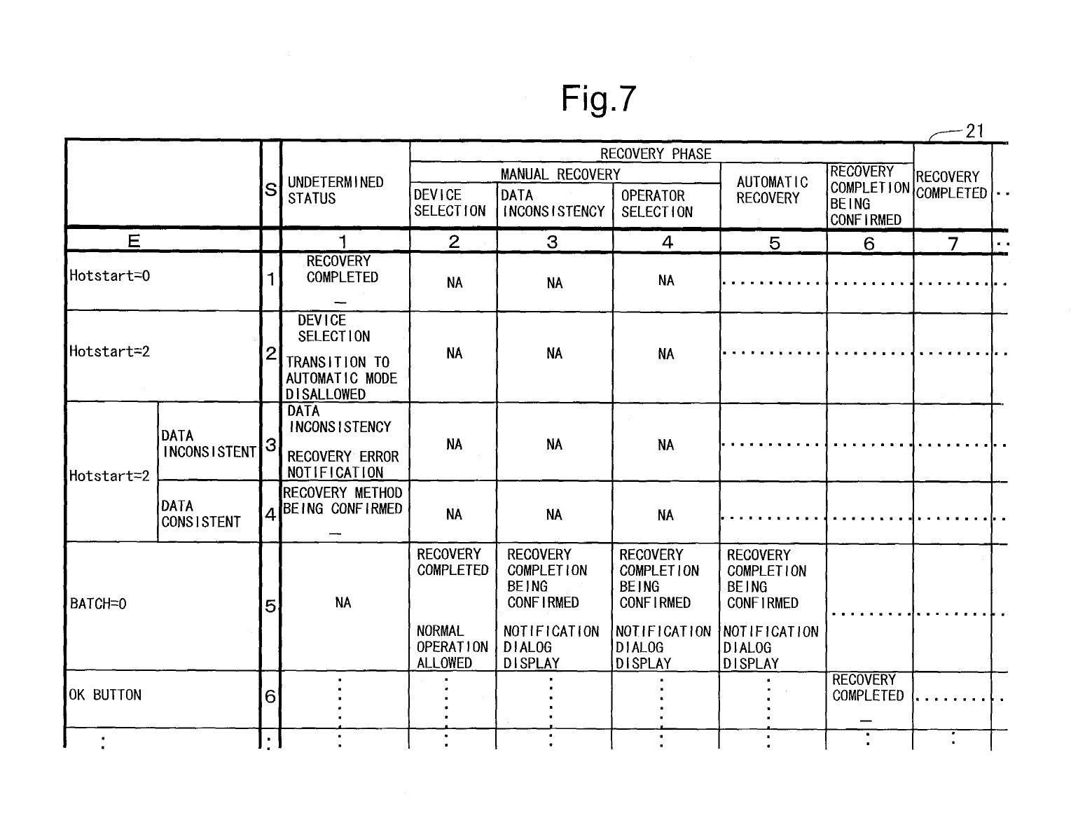

FIG. 7 is a diagram illustrating a portion of a status transition table 21 for a recovery-related system. The status transition test support device 7 according to the present embodiment provides various functions to be described later, such that a status transition test (for a target system) using the status transition table 21 as shown can be efficiently performed.

<3. Functional Configuration>

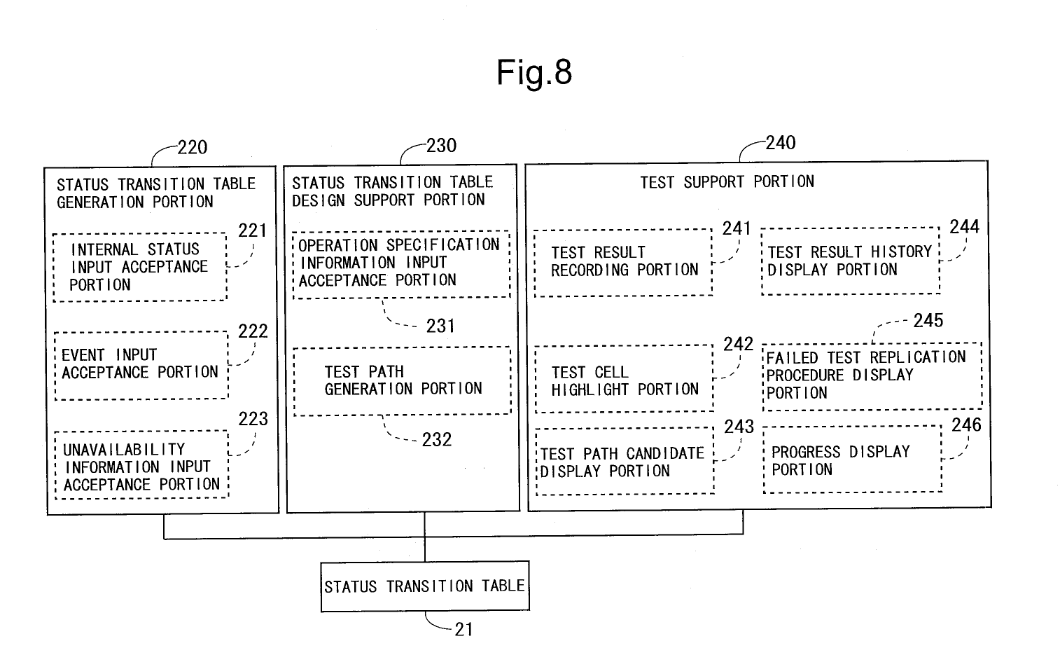

FIG. 8 is a functional block diagram showing the status transition test support device 7 from the functional perspective. The status transition test support device 7 includes a status transition table generation portion 220, a status transition table design support portion 230, and a test support portion 240. The status transition table generation portion 220 includes an internal status input acceptance portion 221, an event input acceptance portion 222, and an unavailability information input acceptance portion 223. The status transition table design support portion 230 includes an operation specification information input acceptance portion 231 and a test path generation portion 232. The test support portion 240 includes a test result recording portion 241, a test cell highlight portion 242, a test path candidate display portion 243, a test result history display portion 244, a failed test replication procedure display portion 245, and a progress display portion 246. Note that these functions are realized by executing the aforementioned programs stored in the file storage portion 20 via the CPU 10 using the memory 60. Specifically, the status transition table generation portion 220 is realized by executing the status transition table generation program 22. Also, the status transition table design support portion 230 is realized by executing the status transition table design support program 23. Furthermore, the testv portion 240 is realized by executing the test support program 24.

The status transition table generation portion 220 generates the status transition table 21 based on data inputted by the operator. Note that “generating the status transition table 21” here refers to generating the status transition table 21 with internal statuses inputted into the internal status input display portion 211, events inputted into the event input display portion 212, and unavailability settings made for combination information cells. The internal status input acceptance portion 221 accepts input by the operator of descriptions representing internal statuses that can be taken by the target system. The event input acceptance portion 222 accepts input by the operator of descriptions representing events that can occur in the target system. The unavailability information input acceptance portion 223 accepts unavailability settings by the operator for combination information cells associated with any “combination of internal status and event” that cannot occur in the target system.

The status transition table design support portion 230 provides various functions to the operator when designing the status transition table 21, such that the operator can efficiently design the status transition table 21. Note that “designing the status transition table” here refers to inputting “transition destination” and “contents of processing” to combination information cells in the status transition table 21 generated by the status transition table generation portion 220, excluding combination information cells for which unavailability settings have been made. The operation specification information input acceptance portion 231 accepts input into combination information cells by the operator, concerning descriptions representing the “transition destination” and the “contents of processing”. The test path generation portion 232 generates a test path based on the “transition destinations” inputted into the combination information cells. Note that a detailed description of the test path will be provided later.

The test support portion 240 provides various functions as will be described later, thereby supporting efficient execution of the status transition test by the operator. Based on test results inputted by the operator, the test result recording portion 241 writes the test results and the like into the test result holding table 31. The test cell highlight portion 242 highlights a combination information cell associated with the next test case to be executed, during execution of the status transition test. When there are a plurality of test paths including any unexecuted test case, the test path candidate display portion 243 displays the test paths as candidates for the next test path to be executed. The test result history display portion 244 displays test results for executed test cases on the display portion 40 in order of test execution. For any test case with the test result “fail (error)”, the failed test replication procedure display portion 245 displays the procedure for test replication on the display portion 40. The progress display portion 246 displays information indicative of the status transition test progress on the display portion 40.

<4. Tables>

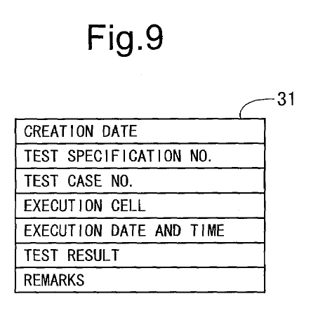

Described next are tables used on the status transition test support device 7. FIG. 9 is a diagram illustrating the record format of the test result holding table 31. The test result holding table 31 contains a plurality of items, which are respectively termed “creation date”, “test specification No.”, “test case No.”, “execution cell”, “execution date and time”, “test result”, and “remarks”. Stored in item fields (areas in which to store individual data items) of the test result holding table 31 are data having contents as described below. Stored in the “creation date” field is the date of creating a record (the date of inserting the record to the test result holding table 31). Stored in the “test specification No.” field is a number for identifying a test specification. Stored in the “test case No.” field is a number for identifying a test case. Stored in the “execution cell” field is a column-row number for a combination information cell, which is assigned for identifying the combination information cell of the status transition table 21 to which the test is applied. Stored in the “execution date and time” field is the date and time of test execution (e.g., year, month, day, and time). Stored in the “test result” field is a test execution result (e.g., “pass”, “fail”, or “unexecuted”). Stored in the “remarks” field is a text memo inputted by the operator.

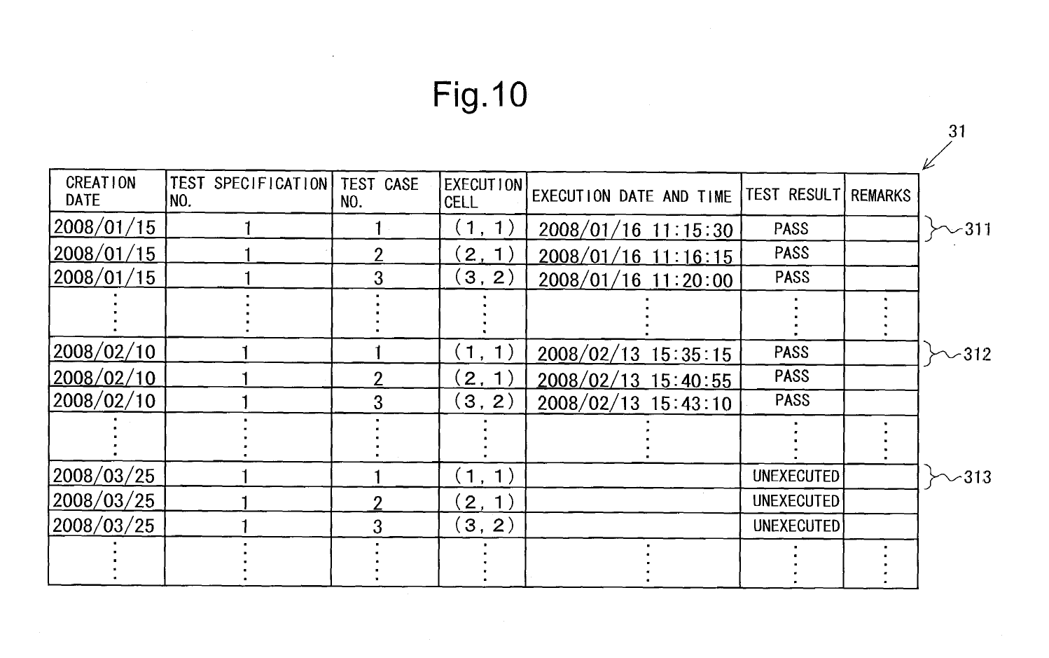

Each record stored in the test result holding table 31 is uniquely identified by a combination of “creation date”, “test specification No.”, and “test case No.”. This will be described with reference to FIG. 10. In software system development, it is often the case that one test is repeatedly executed. Specifically, “a test case included in a test specification may be repeatedly executed”. Accordingly, for such a repeatedly-executed test case, data is held, indicating results for each and every number of times of test execution. For example, in FIG. 10, there are three records with “test specification No.=1” and “test case No.=1” (records with reference numerals 311, 312, and 313). Accordingly, a record cannot be uniquely identified by a combination of “test specification No.” and “test case No.” alone. Here, the above three records differ in creation date. Therefore, a record is uniquely identified by a combination of “creation date”, “test specification No.”, and “test case No.”.

<5. Operation>

Described next is the operation of the status transition test support device 7 according to the present embodiment.

<5.1 Status Transition Table Generation Process>

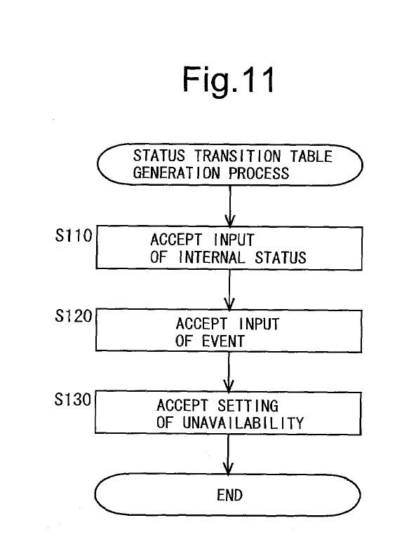

FIG. 11 is a flowchart illustrating the procedure for a status transition table generation process in the present embodiment. Once the operator selects a menu or suchlike, the status transition table generation portion 220 displays a screen for generating the status transition table 21 on the display portion 40. When the operator inputs data into an internal status cell, the internal status input acceptance portion 221 accepts the data as a description representing an internal status (step S110) In addition, when the operator inputs data into an event cell, the event input acceptance portion 222 accepts the data as a description representing an event (step S120). Furthermore, the unavailability information input acceptance portion 223 accepts unavailability setting (input of “NA”) for a combination information cell (step S130). Note that in FIG. 11, steps are shown in the order: “S110, S120, S130”, but this is not restrictive. Also, for example, after an event is inputted subsequent to input of an internal status, another internal status may be inputted. When the operator completes internal status input, event input, and unavailability setting, the status transition table generation process ends.

<5.2 Status Transition Table Design Support Process>

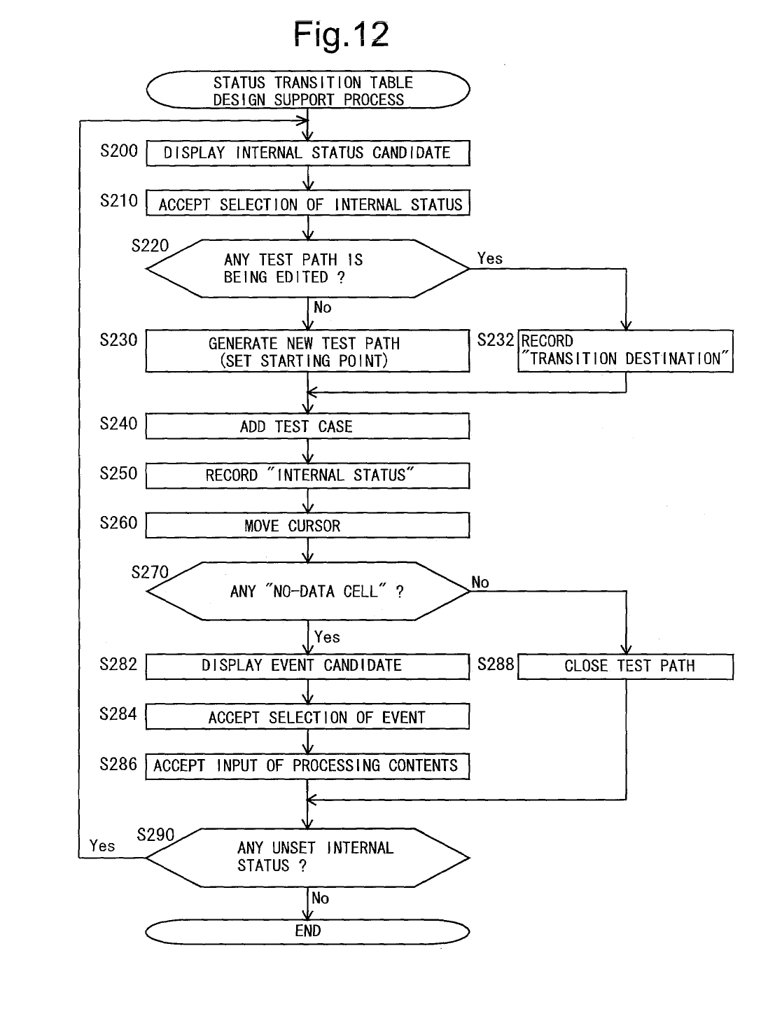

FIG. 12 is a flowchart illustrating the procedure for a status transition table design support process in the present embodiment. Once the operator selects a menu or suchlike for designing the status transition table 21, the status transition table design support portion 230 displays a list of internal statuses (columns) containing any combination information cell without input data (i.e., any combination information cell for which unavailability setting has not yet been made and in which the transition destination and the contents of processing have not yet been inputted; hereinafter, such a cell will be referred to as a “no-data cell”) as “candidates (for the internal status) for which status transition is about to be designed” (step S200). For example, where there is a “no-data cell” in both the internal status columns labeled “STATUS X” and “STATUS Y”, the status transition table design support portion 230 displays on the display portion 40 a screen for prompting the operator to select either “STATUS X” or “STATUS Y”. After step S200, the procedure advances to step S210, where the status transition table design support portion 230 accepts selection of the internal status by the operator. After step S210, the procedure advances to step S220.

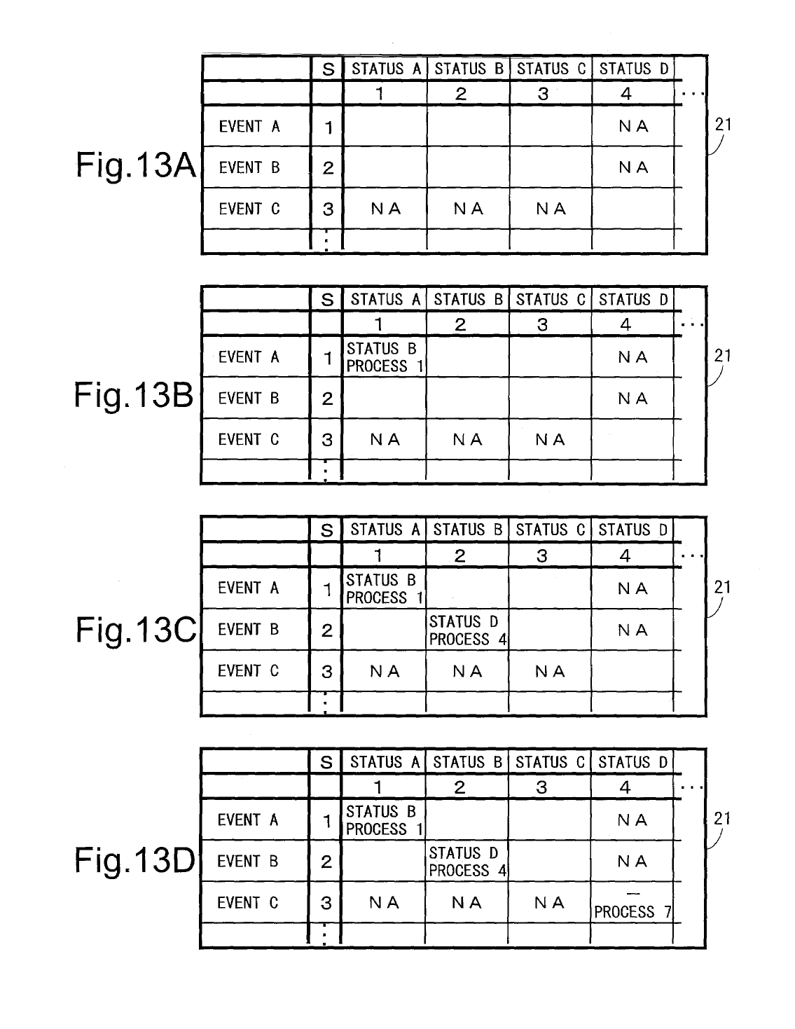

In step S220, the status transition table design support portion 230 determines whether any test path is being edited. Here, the test path will be described with reference to FIGS. 13A to 13D. For example, where there is a status transition table 21 as shown in FIG. 13A, data is inputted into the combination information cell with column-row number (1,1), as shown in FIG. 13B. Then, data is inputted into a combination information cell that belongs to the event row labeled “EVENT B” and to the column for the “transition destination (STATUS B)” inputted into the combination information cell with column-row number (1,1), i.e., data is inputted into the combination information cell with column-row number (2,2), as shown in FIG. 13C. Furthermore, data is inputted into a combination information cell that belongs to the event row labeled “EVENT C” and to the column for the “transition destination (STATUS D)” inputted into the combination information cell with column-row number (2,2), i.e., data is inputted into the combination information cell with column-row number (4,3), as shown in FIG. 13D. When the above inputs are made, status transition can be made in the target system in the order: “(1,1), (2,2), (4,3)”, with the starting internal status “STATUS A”. Therefore, it has to be tested whether the status transition in the order: “(1,1), (2,2), (4,3)” is correctly made. While testing for a combination information cell corresponding to one column-row number is associated with one test case, the test path consists of a plurality of test cases and is a concept that encompasses the order of test execution as well.

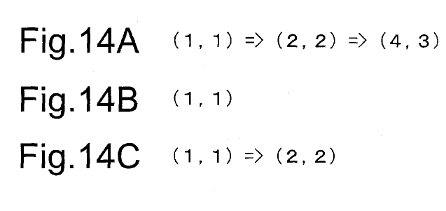

In the above example, a test path as shown in FIG. 14A is generated. Accordingly, when the test path is as shown in FIG. 14B or 14C, it is determined (judged) that the test path is “being edited”.

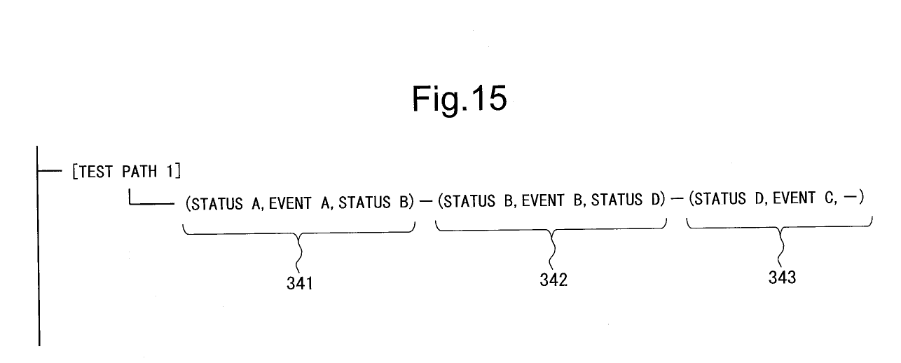

If the determination result in step S220 of FIG. 12 is that there is no test path being edited, the procedure advances to step S230. On the other hand, if there is any test path being edited, the procedure advances to step S232. Note that in FIGS. 14A to 14C, the test path is simply represented by column-row numbers and arrows, but in the status transition test support device 7, for example, data with a list structure as shown in FIG. 15 is created data. In FIG. 15, the data items denoted by reference numerals 341, 342, and 343 correspond to the combination information cells with column-row numbers (1,1), (2,2), and (4,3), respectively. In addition, the data items denoted by reference numerals 341, 342, and 343 are each equivalent to a single test case. Accordingly, in the context of the test path data, data items such as those denoted by reference numerals 341 to 343 are simply referred to as “test cases”.

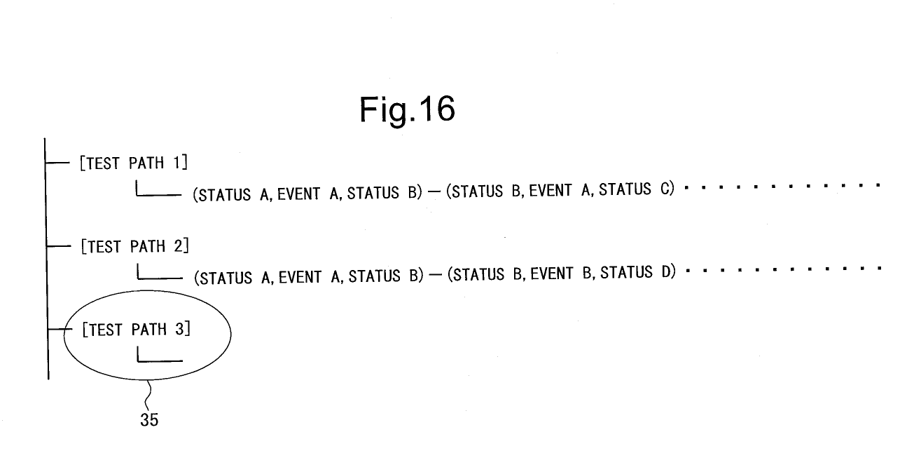

In step S230, the test path generation portion 232 generates a new test path. Note that “generating a new test path” here refers to generating test path data only containing a header portion, such as the data denoted by reference numeral 35 in FIG. 16. After step S230, the procedure advances to step S240.

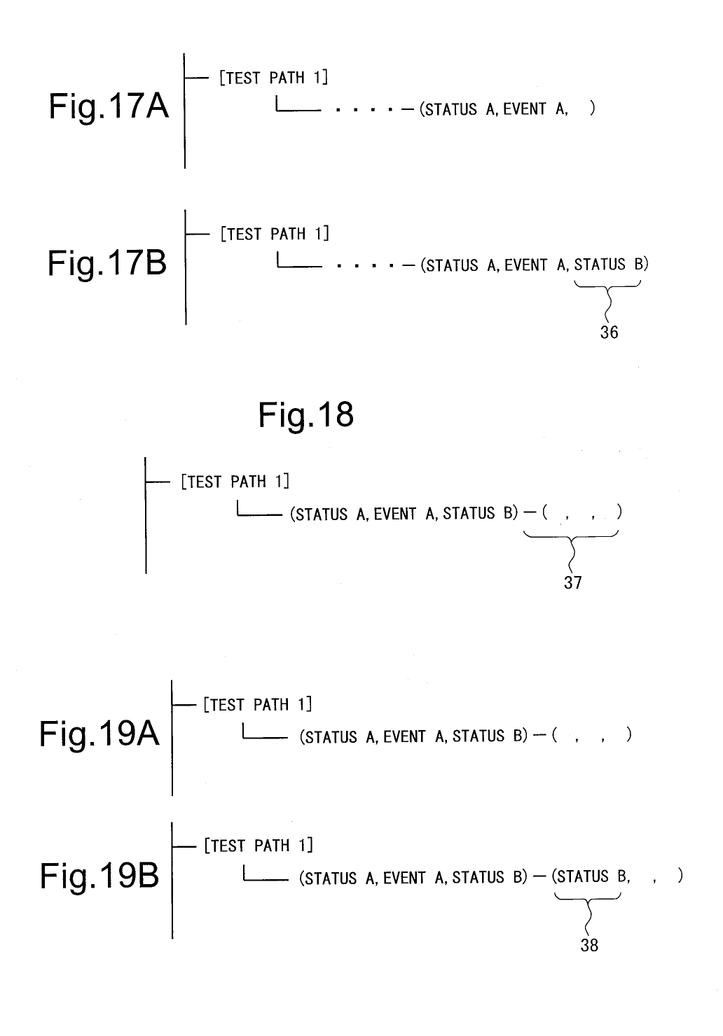

In step S232, the test path generation portion 232 records the internal status accepted in step S210 as the “transition destination” for the last test case in the test path data being edited. For example, when the test path data being edited is as shown in FIG. 17A, and the internal status “STATUS B” is accepted in step S210, a description representing the “transition destination” (here, “STATUS B”) is added to the test path data being edited, as denoted by reference numeral 36 in FIG. 17B. After step S232, the procedure advances to step S240.

In step S240, the test path generation portion 232 adds a test case to the test path data. Note that “adding a test case” here refers to adding data in which its substantial content is not inputted, i.e., the data as denoted by reference numeral 37 in FIG. 18, to test path data. After step S240, the procedure advances to step S250.

In step S250, the test path generation portion 232 records the internal status accepted in step S210 as the internal status for the last test case in the test path data being edited. For example, when the test path data being edited is as shown in FIG. 19A, and the internal status “B” is accepted in step S210, a description representing the internal status (here, “STATUS B”) is added to the test path data being edited, as denoted by reference numeral 38 in FIG. 19B. After step S250, the procedure advances to step S260.

In step S260, the status transition table design support portion 230 moves a cursor on the screen displaying the status transition table 21 to the column for the internal status accepted in step S210. After step S260, the procedure advances to step S270.

In step S270, the status transition table design support portion 230 determines whether any combination information cell in the column for the internal status accepted in step S210 is a “no-data cell”. If the determination result is that there is any “no-data cell”, the procedure advances to step S282. On the other hand, if there is no “no-data cell”, the procedure advances to step S288.

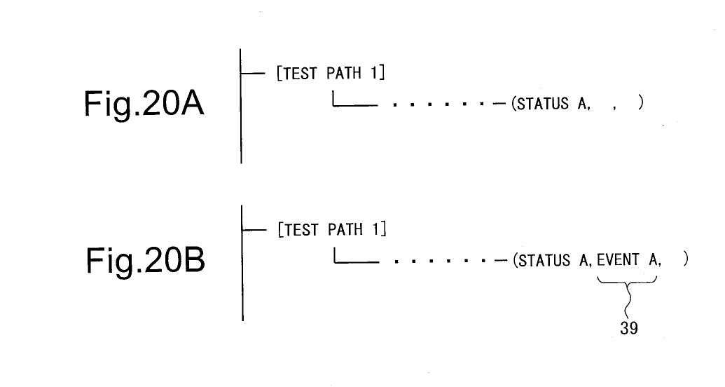

In step S282, the status transition table design support portion 230 displays an event corresponding to the “no-data cell” on the display portion 40 as a candidate for the event to be added to the test path data. After step S282, the procedure advances to step S284, where the operation specification information input acceptance portion 231 accepts event selection by the operator. As a result, the test path generation portion 232 records an event selected by the operator as the event for the last test case in the test path data being edited. For example, when the test path data being edited is as shown in FIG. 20A, and the operator selects “EVENT A”, a description representing the event (here, “EVENT A”) is added to the test path data being edited, as denoted by reference numeral 39 in FIG. 20B. After step S284, the procedure advances to step S286. In step S286, the operation specification information input acceptance portion 231 accepts input of contents of processing to the combination information cell by the operator. After step S288, the procedure advances to step S290.

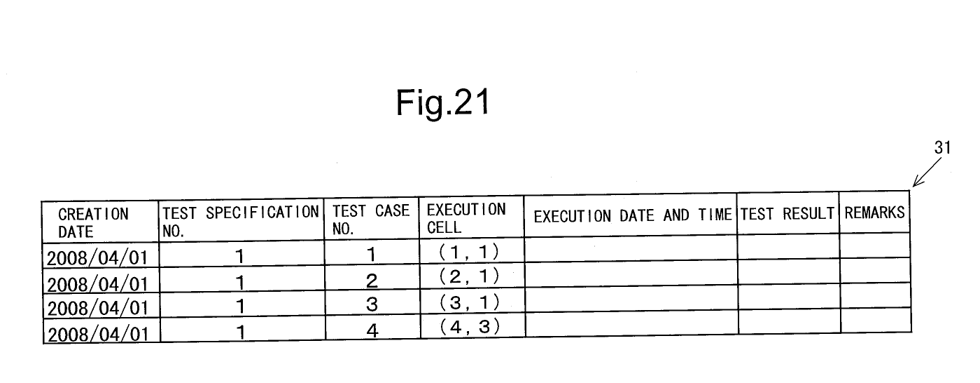

In step S288, the test path generation portion 232 closes the test path. Note that “closing a test path” here refers to precluding any more test cases from being added to the test path being edited. When a test path is closed, data representing the test path is generated in the test result holding table 31. For example, when a test path transitioning in the order: “(1,1), (2,1), (3,1), (4,3)” is closed, data as shown in FIG. 21 is generated in the test result holding table 31. In this manner, when a closed test path includes four test cases, four records are added to the test result holding table 31. After step S288, the procedure advances to step S290.

In step S290, the status transition table design support portion 230 determines whether any internal status column included in the status transition table 21 contains a “no-data cell”. If the determination result is that there is any column containing a “no-data cell”, the procedure returns to step S200. On the other hand, if there is no column containing any “no-data cell”, the status transition table design support process ends.

The status transition table design support process as above makes it possible to input data into all combination information cells in the status transition table 21, so that the operator can complete designing of the status transition table without leaving any “no-data cell” in the table. In addition, the status transition table design support process generates test paths without imposing undue workload on the operator such that the status transition test can be efficiently executed.

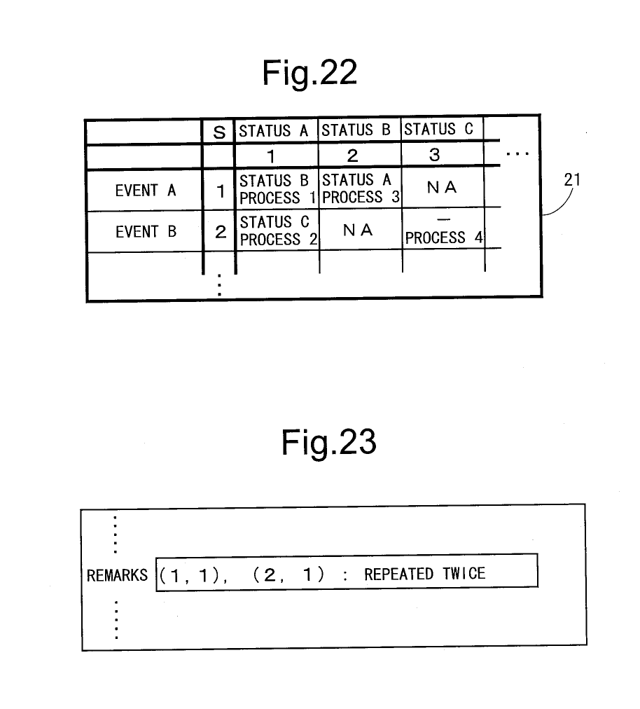

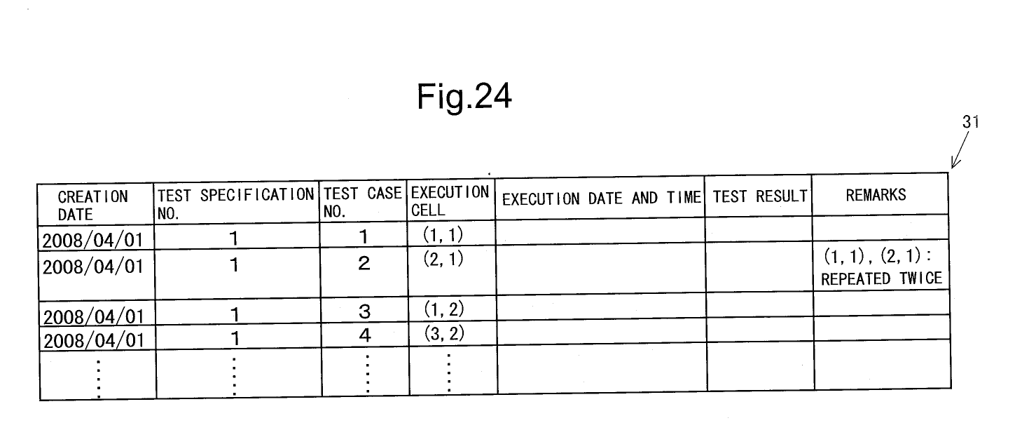

Incidentally, as for internal status transition of a system, similar patterns of status transition can be repeated a plurality of times. For example, in a system having a status transition table 21 as shown in FIG. 22, “STATUS A” and “STATUS B” can be repeated multiple times. Therefore, for example, testing for the status transition in the order: “(1,1), (2,1) (1,1), (2,1), (1,2), (3,2)” may be required. In such a case, in the present embodiment, a description or suchlike representing column-row numbers corresponding to “combinations of internal status and event” to be repeated and the number of repetitions (e.g., a description as shown in FIG. 23) may be inputted in advance into the remarks field of the combination information cell, so that, when performing a status transition test, the operator can repeat the test with reference to the remarks field. After the test path is closed subsequent to the input of the description as shown in FIG. 23, records as shown in FIG. 24 are added to the test result holding table 31.

<5.3 Test Support Process>

<5.3.1 Operating Procedure>

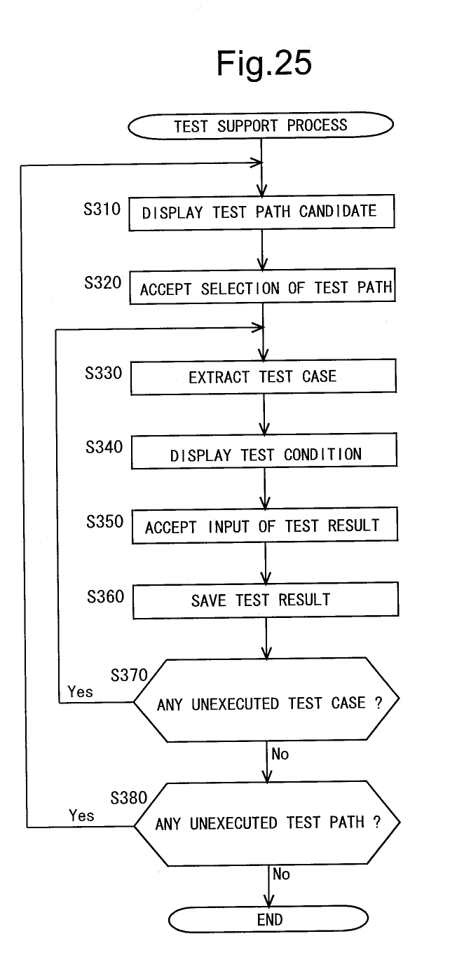

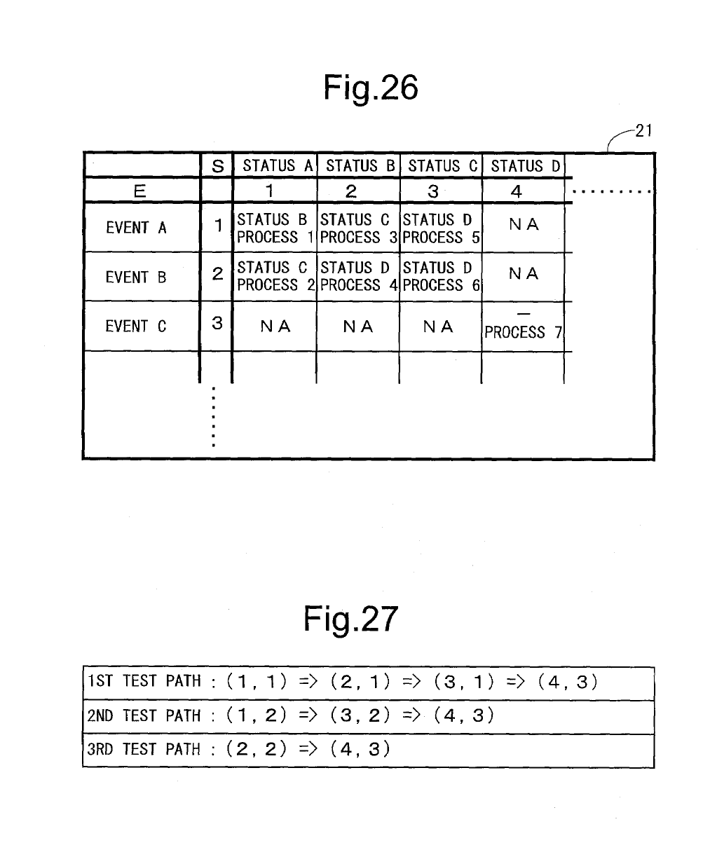

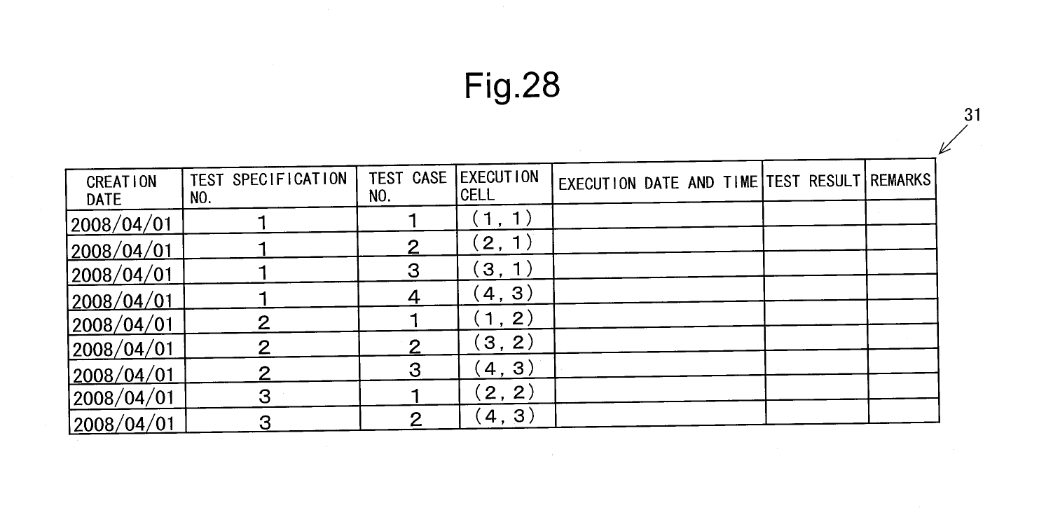

FIG. 25 is a flowchart illustrating the procedure for a test support process in the present embodiment. Note that a description given here assumes that a status transition table 21 as shown in FIG. 26 has already been generated. In addition, it is assumed that the starting internal status of the target system is “STATUS A”. Correspondingly, three test paths as shown in FIG. 27 have already been generated by the above-described status transition table design support process. In addition, the test result holding table 31 has stored therein records as shown in FIG. 28. Note that in FIG. 28, the records with test specification Nos. 1 to 3 are respectively for the first through third test paths in FIG. 27.

When the operator selects a menu or suchlike for starting the status transition test, the test path candidate display portion 243 displays candidates for the test path to be executed on the display portion 40, for example, in the form of a list as shown in FIG. 27 (step S310). Thereafter, the procedure advances to step S320, where the test support portion 240 accepts selection of a test path by the operator (hereinafter, a test path selected as an execution target will be referred to as a “test-target path”.). After step S320, the procedure advances to step S330.

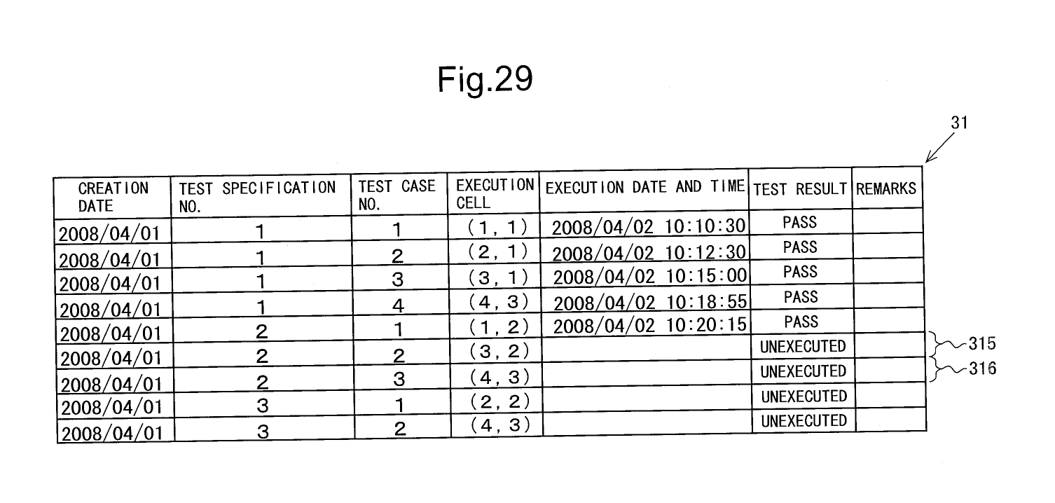

In step S330, the test support portion 240 extracts a test case to be currently executed from among test cases included in the test-target path based on data stored in the test result holding table 31. For example, when the test result holding table 31 has stored therein records as shown in FIG. 29, it can be appreciated that test cases corresponding to two records in the second test path for which no test result is inputted (the records denoted by reference numerals 315 and 316, respectively) have not yet been executed. In addition, when comparing the two records, the record denoted by reference numeral 315 has a smaller test case number than the record denoted by reference numeral 316. Therefore, the test case corresponding to the record denoted by reference numeral 315 is extracted as the test case to be currently executed. Then, the test cell highlight portion 242 moves the cursor to a combination information cell associated with the extracted test case, and displays the combination information cell in a color different from other cells. In this manner, the combination information cell associated with the test case to be currently executed is highlighted. After step S330, the procedure advances to step S340.

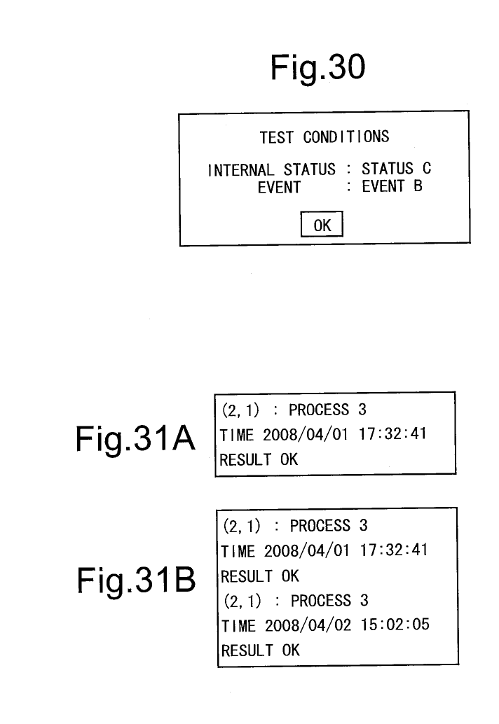

In step S340, the test support portion 240 displays on the display portion 40 a dialog presenting test conditions (which internal status should be assumed by the target system and which event should occur) for the test case extracted in step S330. For example, a screen as shown in FIG. 30 is displayed on the display portion 40. After step S340, the procedure advances to step S350.

Here, the operator executes the test with reference to the screen displayed in step S340. Thereafter, the operator inputs test results. A test result is inputted, for example, by selecting a predetermined menu with a target combination information cell being selected. Then, in step S350, the input of the test results is accepted by the test support portion 240. As a result, any combination information cell in which the test result has been inputted holds information as shown in, for example, FIG. 31A. Note that if inputting a test result into one combination information cell is performed any number of times rather than once, the combination information cell will hold information about test results for that number of times, as shown in, for example, FIG. 31B. That is, each combination information cell is configured to be able to store a plurality of test results. Note that temporal information (year, month, day, and time) in FIGS. 31A and 31B can be obtained by the system without manual input by the operator.

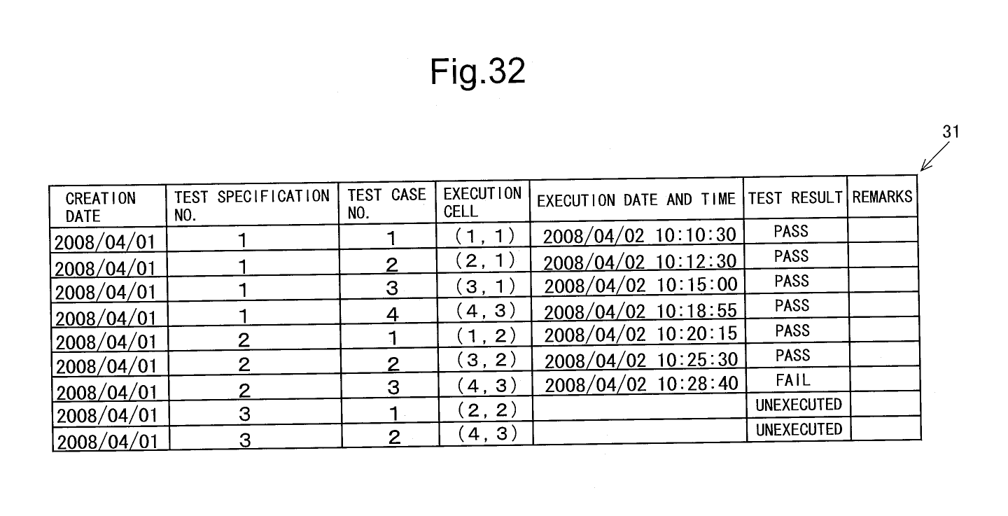

After step S350, the procedure advances to step S360, where the test result recording portion 241 writes the test results accepted in step S350 into the test result holding table 31. At this time, the test result recording portion 241 records the year, month, day, and time of test execution to the test result holding table 31 as information (execution order specification information) for specifying the order of test execution. As a result, for example, all test cases included in the first and second test paths are completely executed, and when only the test result for the test case which was executed last is “fail”, the records stored in the test result holding table 31 are as shown in FIG. 32. After step S360, the procedure advances to step S370.

In step S370, the test support portion 240 determines whether any test case included in the test-target path has not yet been executed. If the determination result is that there is any unexecuted test case, the procedure returns to step S330. On the other hand, if there is no unexecuted test case, the procedure advances to step S380. In step S380, the test support portion 240 determines whether there is any test path that has not yet been executed. If the determination result is that there is any unexecuted test path, the procedure returns to step S310. On the other hand, if there is no unexecuted test path, the test support process ends.

<5.3.2 Various Display Processes>

Described next are various display processes involved in the test support process. The status transition test support device 7 according to the present embodiment has functions for performing the following display processes in order to support efficient execution of the status transition test.

<5.3.2.1 Test Result History Display Process>

In the status transition test, the test result for a given combination information cell can vary in accordance with internal status transition before test execution for the combination information cell. For example, as for the test result for a combination information cell corresponding to a combination of “STATUS C” and “EVENT C”, the test result may be “pass” when the test is executed immediately after internal status transition from “STATUS A”, whereas it may be “fail” when executed after internal status transition from “STATUS A” to “STATUS B”. Therefore, for the system, it is preferable to be readily recognizable as to how the test result varies when the status transition occurs differently.

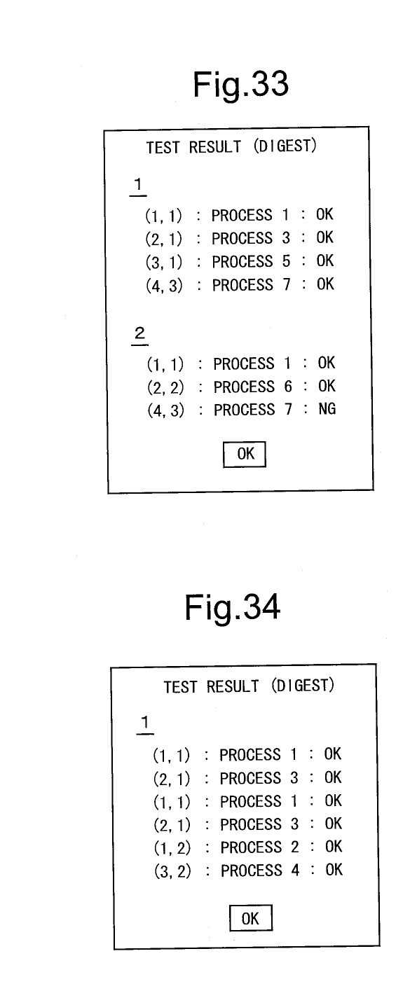

Incidentally, in the present embodiment, results for the status transition test are stored in the test result holding table 31, along with test execution dates and times. In addition, the test result holding table 31 has column-row numbers stored in the “execution cell” fields in order to identify combination information cells to which the test was applied. Therefore, for an arbitrary combination information cell, it is possible to obtain information about a plurality of test paths including the arbitrary combination information cell, regarding in what order and which combination information cells were tested before the arbitrary combination information cell was tested, and also regarding which test results were obtained. Accordingly, the status transition test support device 7 according to the present embodiment is provided with the function of accepting selection of any combination information cell by the operator and displaying on the display portion 40 a test execution history for a test path including the selected combination information cell. This function is realized by the test result history display portion 244. For example, when a predetermined menu is selected with the combination information cell with column-row number (4,3) being selected, the test result history display portion 244 displays a screen as shown in FIG. 33 or 34 on the display portion 40. Note that when the test path including the selected combination information cell (hereinafter, referred to as the “selected cell”) includes any combination information cell to be tested after the selected cell (hereinafter, referred to as a “subsequent cell”), information about the test result for the subsequent cell may be displayed on the screen as well. Incidentally, FIG. 34 is an exemplary display for a case where the status transition in the order: “(1,1), (2,1)” is repeated twice. In such a case, the test execution date and time may be displayed in order to distinguish between the first and second transitions.

<5.3.2.2 Failed Test Replication Procedure Display Process>

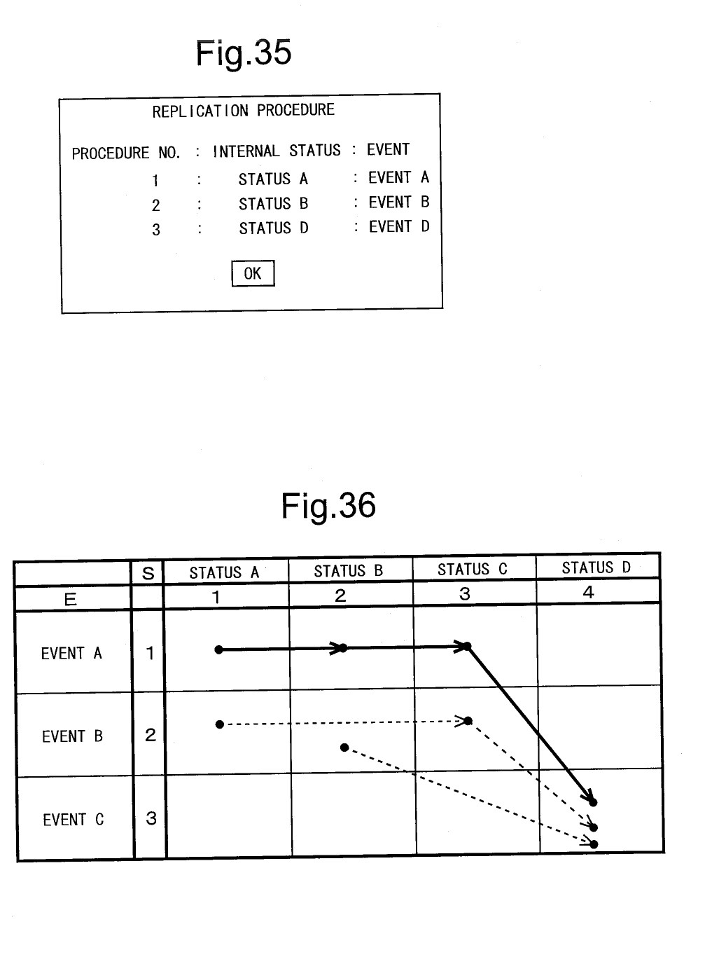

In software system testing, it is often the case that, when an error occurs during a test, replication of the situation of error occurrence is attempted, for example, in order to trace the cause of the error. Therefore, for the system, it is preferable to be readily recognizable as to the procedure for replicating the situation of error occurrence. Incidentally, in the present embodiment, results for the status transition test are stored in the test result holding table 31, along with test execution dates and times. Accordingly, for an arbitrary test case with test result “fail” (error), it is possible to recognize in what order and which test cases were executed before the arbitrary test case was executed. Accordingly, the status transition test support device 7 according to the present embodiment is provided with the function of displaying the procedure for replicating the test with test result “fail” on the display portion 40. This function is realized by the failed test replication procedure display portion 245. For example, when a predetermined menu is selected, the failed test replication procedure display portion 245 displays a screen as shown in FIG. 35 on the display portion 40. With this, it is possible to recognize that the situation of error occurrence can be replicated by causing a “combination of internal status and event” to transition in the order: “STATUS A, EVENT A”, “STATUS B, EVENT B”, “STATUS D, EVENT D”.

<5.3.2.3 Status Transition Test Progress Display Process>

In software system development, it is important for a project leader or suchlike to manage the progress of each operation. Therefore, for the system, it is preferable to be readily recognizable as to the progress of the status transition test. Incidentally, in the present embodiment, information regarding test paths based on the status transition table 21 and information regarding test results for test cases included in each test path are stored in the test result holding table 31. Therefore, it is possible to readily recognize the presence or absence of any unexecuted test case for each test path. Accordingly, the status transition test support device 7 according to the present embodiment is provided with the function of displaying the progress of the status transition test on the display portion 40. This function is realized by the progress display portion 246. For example, when a predetermined menu is selected, the progress display portion 246 displays a screen as shown in FIG. 36 on the display portion 40. Note that FIG. 36 shows an example where an executed test path is denoted by bold lines, and unexecuted test paths are denoted by dotted lines.

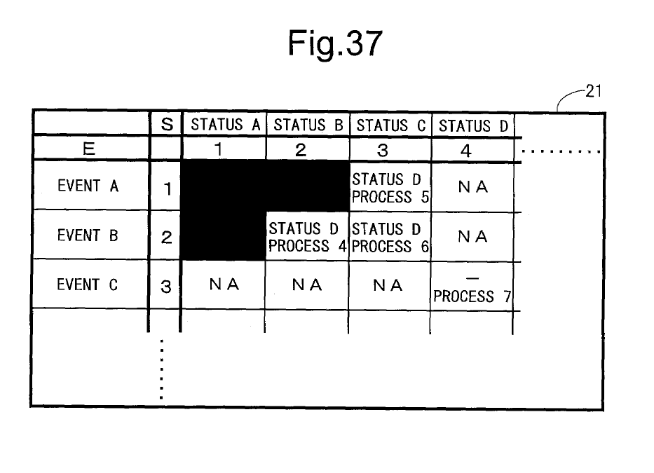

In addition, in the present embodiment, test result information for each test case is stored in the test result holding table 31, and each test case is associated with a combination information cell. Therefore, for each combination information cell, it is possible to recognize whether its corresponding test case has already been executed. Accordingly, the status transition test support device 7 according to the present embodiment is provided with the function of displaying combination information cells corresponding to executed test cases and combination information cells corresponding to unexecuted test cases so as to be distinguished therebetween on the display portion 40. This function is also realized by the progress display portion 246. For example, when a predetermined menu is selected, the progress display portion 246 displays a screen as shown in FIG. 37 on the display portion 40. Note that FIG. 37 shows an example where combination information cells corresponding to executed test cases are blacked out. In addition, when there is any combination information cell associated with a plurality of test cases, for example, such a combination information cell may be displayed so as to be distinguished as to whether or not all test cases have already been executed.

<6. Effects>

According to the present embodiment, when designing the status transition table 21, the status transition table design support portion 230 presents to the operator candidates for internal statuses and events that should be designed. Accordingly, it is possible to eliminate the necessity for the operator to find by him/herself any internal status or event that has not yet been designed, resulting in quick designing of the status transition table. In addition, when the operator inputs “combinations of internal status and event” to cells (combination information cells) of the status transition table 21, the test path generation portion 232 generates a test path to be executed as a status transition test based on the contents of the input. Thus, it is possible to significantly shorten the time conventionally required for test path generation.

In addition, when the status transition test is executed, the test result for each test case included in the test path is recorded to the test result holding table 31. At this time, the year, month, day, and time of test execution is recorded to the test result holding table 31 as information for specifying the order of test execution (execution order specification information). Thus, it is possible to determine in which test path and up to which test case has already been executed based on data held by the test result holding table 31.

Furthermore, according to the present embodiment, during execution of the status transition test, the test cell highlight portion 242 highlights a combination information cell associated with the next test case to be executed. Thus, it is possible to eliminate the necessity for the operator to find by him/herself the next combination information cell to be tested, resulting in quick execution of the status transition test. In addition, when there are a plurality of test paths including any unexecuted test case, the test path candidate display portion 243 presents to the operator candidates for the next test path to be executed. Thus, it is possible to eliminate the necessity for the operator to find by him/herself the test path to be executed, resulting in quick execution of the status transition test.

Furthermore, the test result history display portion 244 displays test results for executed test cases on the display portion 40 in order of test execution. Thus, it is possible to readily recognize the progress of execution for the status transition test. In addition, the failed test replication procedure display portion 245 displays the procedure for test replication for any test case with test result “error” on the display portion 40. Thus, it is possible to readily trace the cause of the error, thereby achieving efficient system development. In addition, the progress display portion 246 displays information indicating the progress of testing on the display portion 40. Thus, it is possible to readily manage the progress of system development including the status transition test.

<7. Others>

The above-described status transition test support device 7 is realized based on programs 22 to 24 for test support and so on, which are executed by the CPU 10 given the presence of hardware such as the memory 60 and the auxiliary storage device 70. Part or all of the programs 22 to 24 is provided by, for example, a computer-readable recording medium, such as a CD-ROM, which has the programs 22 to 24 recorded thereon. The user can purchase a CD-ROM as a recording medium of the programs 22 to 24, and load the CD-ROM into a CD-ROM drive unit (not shown), so that the programs 22 to 24 are read therefrom and installed to the auxiliary storage device 70 of the status transition test support device 7. In this manner, it is possible to provide programs causing a computer to execute each step shown in FIG. 25 and so on.

While the invention has been described in detail, the foregoing description is in all aspects illustrative and not restrictive. It is understood that numerous other modifications and variations can be devised without departing from the scope of the invention.

Note that the present application claims priority to Japanese Patent Application No. 2008-112490, titled “STATUS TRANSITION TEST SUPPORT DEVICE, STATUS TRANSITION TEST SUPPORT PROGRAM, AND STATUS TRANSITION TEST SUPPORT METHOD”, filed on Apr. 23, 2008, and hereby incorporated by reference in its entirety.

What is claimed is:

1. A status transition test support device for supporting execution of a status transition test for transition between internal statuses to be taken by a system, the test including a plurality of test cases, the device comprising:
a status transition table generation portion for generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, wherein the combination information cells are associable with the test cases included in the status transition test, and the described information is either operation specification information or unavailability information, the operation specification information specifying contents of processing and an internal status after transition, the unavailability information indicating that a combination of internal status and event does not occur in the system;
an operation specification information input acceptance portion for accepting input of the operation specification information into the combination information cells;
a test path generation portion for generating a test path including a series of test cases to be executed as the status transition test, based on the operation specification information accepted by the operation specification information input acceptance portion;
a test result holding portion for holding test results for the test cases included in the test path generated by the test path generation portion, and execution order specification information for specifying the order of test execution; and
a test result recording portion for recording a test result externally inputted for each test case to the test result holding portion, along with the execution order specification information.

2. The status transition test support device according to claim 1, further comprising a test cell highlight portion for highlighting a combination information cell associated with the next test case to be executed, based on the test path generated by the test path generation portion.

3. The status transition test support device according to claim 2, wherein the test cell highlight portion displays the combination information cell associated with the next test case to be executed in a color different from any other combination information cell.

4. The status transition test support device according to claim 2, wherein the test cell highlight portion moves a cursor for selecting one or more cells included in the status transition table to the combination information cell associated with the next test case to be executed.

5. The status transition test support device according to claim 1, further comprising a test path candidate display portion for displaying a plurality of test paths including any unexecuted test case as candidates for the next test path to be executed, based on the test result held by the test result holding portion for each test case.

6. The status transition test support device according to claim 1, further comprising a test result history display portion for displaying test results for any executed test cases, along with an information for identifying test cases, in order of test execution, based on the test result for each test case and the execution order specification information which are held by the test result holding portion.

7. The status transition test support device according to claim 6, wherein the test result history display portion displays test results for test cases included in a test path including a test case associated with an externally designated combination information cell.

8. The status transition test support device according to claim 6, wherein the test result history display portion displays at least numbers denoting combination information cells associated with test cases and contents of processing described in the combination information cells as the information for identifying test cases.

9. The status transition test support device according to claim 1, wherein the test result holding portion holds information indicating whether the test was passed or failed as the test result, the device further comprising:
a failed test replication procedure display portion for displaying execution methods for one or more test cases in order of test execution for the one or more test cases, based on the test result for each test case and the execution order specification information which are held by the test result holding portion, provided that the one or more test cases have been executed before executing a test case whose test result is fail.

10. The status transition test support device according to claim 9, wherein the failed test replication procedure display portion displays the execution methods for test cases in a test path including the test case whose test result is fail, starting from the first test case to be executed up to the test case whose test result is fail.

11. The status transition test support device according to claim 9, wherein the failed test replication procedure display portion displays as the execution methods at least an internal status and an event that are associated with the one or more test cases.

12. The status transition test support device according to claim 1, further comprising a progress display portion for displaying progress of the status transition test based on the test result held by the test result holding portion for each test case.

13. The status transition test support device according to claim 12, wherein the progress display portion displays test paths including any unexecuted test case and any other test path so as to be distinguished therebetween.

14. The status transition test support device according to claim 12, wherein the progress display portion displays combination information cells associated with executed test cases and combination information cells associated with unexecuted test cases so as to be distinguished therebetween.

15. The status transition test support device according to claim 1, wherein the execution order specification information contains for each test case the year, month, day, and time of test execution.

16. A computer-readable recording medium having recorded thereon a status transition test support program for use with a status transition test support device for supporting execution of a status transition test for transition between internal statuses to be taken by a system, the test including a plurality of test cases, the program causing the device to execute the following steps:
a status transition table generation step of generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, wherein the combination information cells are associable with the test cases included in the status transition test, and the described information is either operation specification information or unavailability information, the operation specification information specifying contents of processing and an internal status after transition, the unavailability information indicating that a combination of internal status and event does not occur in the system;
an operation specification information input acceptance step of accepting input of the operation specification information into the combination information cells;
a test path generation step of generating a test path including a series of test cases to be executed as the status transition test, based on the operation specification information accepted in the operation specification information input acceptance step; and
a test result recording step of recording a test result externally inputted for each test case included in the test path generated in the test path generation step to a predetermined test result holding portion, along with execution order specification information for specifying the order of test execution.

17. The computer-readable recording medium according to claim 16, wherein the status transition test support program further comprises a test cell highlight step of highlighting a combination information cell associated with the next test case to be executed, based on the test path generated in the test path generation step.

18. The computer-readable recording medium according to claim 17, wherein in the test cell highlight step, the combination information cell associated with the next test case to be executed is displayed in a color different from any other combination information cell.

19. The computer-readable recording medium according to claim 17, wherein in the test cell highlight step, a cursor for selecting one or more cells included in the status transition table is moved to the combination information cell associated with the next test case to be executed.

20. The computer-readable recording medium according to claim 16, wherein the status transition test support program further comprises a test path candidate display step of displaying a plurality of test paths including a series of unexecuted test cases as candidates for the next test path to be executed, based on the test result held by the test result holding portion for each test case.

21. The computer-readable recording medium according to claim 16, wherein the status transition test support program further comprises a test result history display step of displaying test results for any executed test cases, along with an information for identifying test cases, in order of test execution, based on the test result for each test case and the execution order specification information which are held by the test result holding portion.

22. The computer-readable recording medium according to claim 21, wherein in the test result history display step, test results are displayed for test cases included in a test path including a test case associated with an externally designated combination information cell.

23. The computer-readable recording medium according to claim 21, wherein in the test result history display step, at least numbers denoting combination information cells associated with test cases and contents of processing described in the combination information cells are displayed as the information for identifying test cases.

24. The computer-readable recording medium according to claim 16, wherein,
the test result holding portion holds information indicating whether the test was passed or failed as the test result, and
the status transition test support program further comprises a failed test replication procedure display step of displaying execution methods for one or more test cases in order of test execution for the one or more test cases, based on the test result for each test case and the execution order specification information which are held by the test result holding portion, provided that the one or more test cases have been executed before executing a test case whose test result is fail.

25. The computer-readable recording medium according to claim 24, wherein in the failed test replication procedure display step, the execution methods are displayed for test cases in a test path including the test case whose test result is fail, starting from the first test case to be executed up to the test case whose test result is fail.

26. The computer-readable recording medium according to claim 24, wherein in the failed test replication procedure display step, at least an internal status and an event that are associated with the one or more test cases are displayed as the execution methods.

27. The computer-readable recording medium according to claim 16, wherein the status transition test support program further comprises a progress display step of displaying progress of the status transition test based on the test result held by the test result holding portion for each test case.

28. The computer-readable recording medium according to claim 27, wherein in the progress display step, test paths including any unexecuted test case and any other test path are displayed so as to be distinguished from therebetween.

29. The computer-readable recording medium according to claim 27, wherein in the progress display step, combination information cells associated with executed test cases and combination information cells associated with unexecuted test cases are displayed so as to be distinguished therebetween.

30. The computer-readable recording medium according to claim 16, wherein the execution order specification information contains for each test case the year, month, day, and time of test execution.

31. A status transition test support method for supporting execution of a status transition test for transition between internal statuses to be taken by a system, the test including a plurality of test cases, the method comprising:
a status transition table generation step of generating a status transition table, the table containing:
internal status cells provided for listing the internal statuses either horizontally or vertically;
event cells provided for listing events occurable in the system either horizontally or vertically in a direction different from the internal status cells; and
combination information cells provided in the form of a matrix for describing information corresponding to combinations of internal statuses described in the internal status cells and events described in the event cells, wherein the combination information cells are associable with the test cases included in the status transition test, and the described information is either operation specification information or unavailability information, the operation specification information specifying contents of processing and an internal status after transition, the unavailability information indicating that a combination of internal status and event does not occur in the system;
an operation specification information input acceptance step of accepting input of the operation specification information into the combination information cells;
a test path generation step of generating a test path including a series of test cases to be executed as the status transition test, based on the operation specification information accepted in the operation specification information input acceptance step; and
a test result recording step of recording a test result externally inputted for each test case included in the test path generated in the test path generation step to a predetermined test result holding portion, along with execution order specification information for specifying the order of test execution.
